(19) United States
(12) Patent Application Publication
(10) Pub. No.: US 2018/0338244 A1
(43) Pub. Date: Nov. 22, 2018

(54) REGULATORY DOMAIN SECURITY TECHNIQUES FOR WIRELESS DEVICES

(71) Applicant: QUALCOMM Incorporated, San Diego, CA (US)

(72) Inventors: Amar Singhal, Cupertino, CA (US); Michael Richard Green, Needham, MA (US); Tarik Isani, San Jose, CA (US); Jeffrey Thomas Johnson, Cupertino, CA (US)

(21) Appl. No.: 15/981,608

(22) Filed: May 16, 2018

Related U.S. Application Data
(60) Provisional application No. 62/507,179, filed on May 16, 2017.

(51) Int. Cl. H04W 12/06; H04W 76/10; H04L 9/32; H04W 12/10

(52) U.S. Cl. CPC H04W 12/06; H04W 76/10; H04W 84/12; H04L 9/3236; H04W 12/10; H04L 9/3247

(57) ABSTRACT

This disclosure may prevent unauthorized modification of country code information stored in a wireless device including a high-level operating system (HLOS) and a radio subsystem including at least a first radio and a second radio. The first radio may receive first country code information from the HLOS, and may receive a message from the second radio. The message may include second country code information and a digital signature. The first radio may verify the message based on the digital signature, and may determine a validity of the first country code information based on a comparison with the second country code information. Transmission parameters of the wireless device may be configured using either the first or second country code information in response to the verifying.

### CROSS-REFERENCE TO RELATED APPLICATIONS

This patent application claims priority to U.S. Provisional Patent Application No. 62/507,179 entitled “REGULATORY DOMAIN SECURITY TECHNIQUES FOR WIRELESS DEVICES” filed on May 16, 2017, which is assigned to the assignee hereof. The disclosure of the prior application is considered part of and are incorporated by reference in this patent application.

### TECHNICAL FIELD

This disclosure relates generally to wireless devices, and specifically to preventing tampering with country code information stored in wireless devices.

### DESCRIPTION OF THE RELATED TECHNOLOGY

A wireless local area network (WLAN) may be formed by one or more access points (APs) that provide a wireless communication channel or link with a number of wireless devices such as stations (STAs). Each AP, which may correspond to a Basic Service Set (BSS), periodically broadcasts beacon frames to enable any wireless devices within wireless range of the AP to establish and maintain a communication link with the WLAN. The beacon frames are typically broadcasted according to a target beacon transmission time (TBTT) schedule.

The IEEE 802.11d standards allow beacon frames broadcast by an AP to include a Country Information Element (IE) indicating a number of regulatory constraints associated with the country or region in which the AP is located. More specifically, the country IE includes a country code that identifies the country, and also includes a list of authorized channels, maximum transmit power levels, and other regulatory restrictions associated with the country. The list of authorized channels, maximum transmit power levels, and other regulatory restrictions vary between countries and regulatory domains. A wireless device receiving these beacon frames may decode the country IE to determine in which country or domain the AP is located, and then configure itself to transmit wireless signals only on the authorized channels using power settings which comply with the applicable transmit power limits.

A default country code is typically stored in a non-volatile memory of a wireless device, for example, by the manufacturer of the wireless device. If the wireless device is operating in another country or region different than the country indicated by the default country code, the wireless device may receive new country code information and update the country code stored in the non-volatile memory. Thereafter, the wireless device may transmit wireless signals according to the updated country code information.

The country code information is typically accessible to the high-level operating system (HLOS) of the wireless device. The HLOS may be accessible to a user via a user interface, which may allow the user to override the country code information stored therein or to replace the existing HLOS with a new HLOS. The accessibility of the HLOS to users may allow a malicious user to improperly modify the country code information stored in the wireless device, for example, to allow the wireless device to transmit wireless signals on unauthorized channels, to transmit wireless signals at power levels that exceed applicable limits, or both. Because operating a wireless device using invalid or incorrect country code information may violate applicable governmental regulations, it is desirable to prevent malicious users from accessing and modifying country code information stored in wireless devices.

### SUMMARY

The systems, methods and devices of this disclosure each have several innovative aspects, no single one of which is solely responsible for the desirable attributes disclosed herein.

One innovative aspect of the subject matter described in this disclosure can be implemented as a method for preventing unauthorized modification of country code information stored in a wireless device. In some implementations, the wireless device can include a high-level operating system (HLOS) and a radio subsystem including at least a first radio and a second radio. The method, which may be performed by the first radio, can include receiving first country code information from the HLOS, and transmitting a request for country code information to the second radio based on receiving the first country code information. In some aspects, the first radio can be a WLAN transceiver, the second radio can be a cellular transceiver, the first country code information can be a Board Data File (BDF) stored in the HLOS, and the second country code information can be a mobile country code (MCC) received from a cellular network. In other aspects, the first radio can be a cellular transceiver, the second radio can be a WLAN transceiver, the first country code information can be a BDF stored in the HLOS, and the second country code information can be a country code received from a Wi-Fi network. In other aspects, the first radio can be a WLAN transceiver, the second radio can be a satellite positioning system (SPS) receiver, the first country code information can be a BDF stored in the HLOS, and the second country code information can be a country code received from the SPS.

The method can also include receiving a message from the second radio in response to the request, the message including second country code information and a digital signature. In some implementations, the message can be sent from the second radio to the first radio via the HLOS using a secure tunnel. In addition, or in the alternative, the message can include a header including the digital signature, and can include a payload including the second country code information, a subsystem identification (ID), and a random nonce.

The method can also include verifying the message based at least in part on the digital signature, and determining a validity of the first country code information based on a comparison with the second country code information. In some implementations, the message can be verified by determining an authenticity of the message based at least in part on the digital signature, and by determining an integrity of the message based at least in part on the second country code information. In some implementations, the digital signature can be based on a hash function of the payload, and the message can be verified by generating a hash of the payload of the received message, decrypting the digital signature to recover the hash function, comparing the recovered hash function with the generated hash, and verifying the message based on the comparison. The method can also include configuring transmission parameters of the wireless device using either the first country code information or the second country code information in response to the verifying.

Another innovative aspect of the subject matter described in this disclosure can be implemented in an apparatus including a high-level operating system (HLOS), a radio subsystem including at least a first radio and a second radio, one or more processors, and a memory storing instructions. In some implementations, execution of the instructions by the one or more processors can cause the first radio to receive first country code information from the HLOS; transmit a request for country code information to the second radio based on receiving the first country code information; receive a message from the second radio in response to the request, the message including second country code information and a digital signature; verify the message based at least in part on the digital signature; determine a validity of the first country code information based on a comparison with the second country code information; and configure transmission parameters of the wireless device using either the first country code information or the second country code information in response to the verifying.

Another innovative aspect of the subject matter described in this disclosure can be implemented in a non-transitory computer-readable medium. The non-transitory computer-readable medium can include instructions that, when executed by one or more processors in a wireless device comprising a high-level operating system (HLOS) and a radio subsystem including at least a first radio and a second radio, cause the first radio to perform a number of operations. In some implementations, the number of operations may include receiving first country code information from the HLOS; transmitting a request for country code information to the second radio based on receiving the first country code information; receiving a message from the second radio in response to the request, the message including second country code information and a digital signature; verifying the message based, at least in part, on the digital signature; determining a validity of the first country code information based on a comparison between the first country code information and the second country code information; and configuring transmission parameters of the wireless device using either the first country code information or the second country code information in response to the verifying.

Another innovative aspect of the subject matter described in this disclosure can be implemented in a wireless device. The wireless device can include a high-level operating system (HLOS) and a radio subsystem including at least a first radio and a second radio. In some implementations, the wireless device can include means for receiving first country code information from the HLOS; means for transmitting a request for country code information to the second radio based on receiving the first country code information; means for receiving a message from the second radio in response to the request, the message including second country code information and a digital signature; means for verifying the message based at least in part on the digital signature; means for determining a validity of the first country code information based on a comparison with the second country code information; and means for configuring transmission parameters of the wireless device using either the first country code information or the second country code information in response to the verifying.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 is a block diagram of a wireless communication system.

FIG. 2 is a block diagram of an example wireless device.

FIG. 3A is a functional diagram of the wireless device of FIG. 2.

FIG. 3B is another functional diagram of the wireless device of FIG. 2.

FIG. 4A depicts a Country Information Element (IE) that may be transmitted by an access point operating in a wireless local area network (WLAN).

FIG. 4B depicts an Extended System Parameters Message containing a Mobile Country Code (MCC) that may be transmitted by a base station in a wireless wide area network (WWAN).

FIG. 4C depicts a message transmitted from a second radio to a first radio in a wireless device.

FIG. 5 is an illustrative flow chart depicting an example operation for protecting country code information stored in a wireless device.

FIG. 6A is an illustrative flow chart depicting an example operation for verifying a message containing country code information.

FIG. 6B is an illustrative flow chart depicting another example operation for verifying a message containing country code information.

FIG. 7 is a table depicting example transmit power levels for some regulatory domains.

FIG. 8 is a table depicting example transmit power levels for other regulatory domains.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. The described implementations may be implemented in any device, system or network that is capable of transmitting and receiving RF signals according to any of the IEEE 16.11 standards, any of the IEEE 802.11 standards, any of the Bluetooth® standards, and any wide wireless area network (WWAN) operating according to one or more of code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless, cellular or internet of things (IOT) network, such as a system utilizing 3G, 4G or 5G, or further implementations thereof, technology.

Wireless devices use country code information to ensure compliance with applicable governmental regulations that specify authorized channels and transmit power limits for wireless transmissions. Manufacturers typically program a default country code in each wireless device based on the country in which the wireless device is to be sold. Because the authorized channels and transmit power levels may vary between countries, the country code information stored in a wireless device may be updated when the wireless device operates in another country. For example, when a wireless device is moved from its “home” country to a “new” country, the wireless device may receive new country code information from WLAN beacon frames transmitted from access points located in the new country, from cellular messages transmitted from base stations located in the new country, from a satellite positioning system (SPS), or any combination thereof. The wireless device may store the new country code information and thereafter configure its transmissions to be compliant with the regulatory constraints imposed by the new country.

The country code information stored in a wireless device may be accessed by the operating system and user interface of the wireless device, which may allow a user to improperly access and change the stored country code information. For example, a malicious user may store invalid or incorrect country code information in a wireless device in an attempt to allow the wireless device to transmit data on unauthorized channels and at power levels that exceed applicable regulatory constraints.

Implementations of the subject matter described in this disclosure may prevent tampering with country code information stored in a wireless device. In some implementations, the wireless device may store country code information in a memory that is not readily accessible by the operating system, thereby preventing a user from improperly changing the stored country code information using the user interface. In some aspects, the wireless device also may include secure tunnels in the radio subsystem of the wireless device to allow each of the individual radios (such as the cellular radio, the WLAN radio, and a satellite receiver) to securely share valid country code information with each other without the involvement of the operating system. In some aspects, the secure tunnel may be a hardwired connection between the various radios that does not pass through the operating system. In other aspects, the secure tunnel may be a proprietary modem interface provided between the various radios. The ability to securely share valid country code information between different radios of the wireless device may allow the radio subsystem to verify the validity of any changes in country code information received from the operating system.

In addition, or in the alternative, the wireless device also may include digital signature capabilities that allow the various radios of the radio subsystem to prevent tampering of country code information provided to the operating system. The operating system may distribute the protected country code information to the radios of the radio subsystem, which in turn may use a public key to verify the country code information. Because neither the user interface nor the operating system has the private key, a user will not be able to modify the country code information by accessing or changing the operating system.

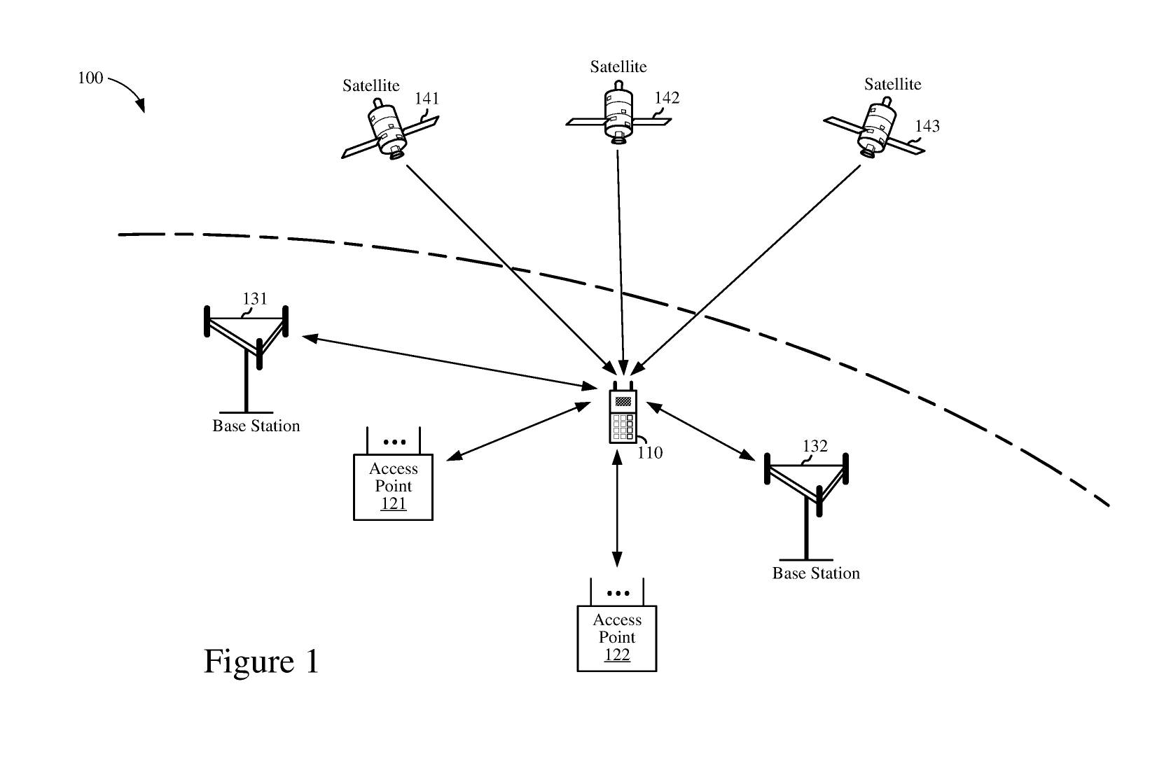

FIG. 1 shows a block diagram of an example wireless communication system 100. The wireless communication system 100 is shown to include a wireless device 110, two access points (APs) 121-122, two base stations 131-132, and three satellites 141-143. The APs 121-122 may form or be part of a wireless local area network (WLAN). A WLAN is a wireless network that provides communication coverage for a medium geographic area such as, for example, a mall, an airport terminal, and so on. In some implementations, the WLAN may operate according to the IEEE 802.11 family of standards (or according to other suitable wireless protocols). Although only two APs 121-122 are shown in FIG. 1 for simplicity, it is to be understood that the WLAN may be formed by any number of APs. The APs 121-122 may facilitate communications between the wireless device 110 and other wireless devices (not shown for simplicity) associated with the WLAN, and also may allow the wireless device 110 to access another network such as, for example, a local area network (LAN), a wireless wide area network (WWAN), a metropolitan area network (MAN), and the Internet using Wi-Fi, Bluetooth, or any other suitable wireless communication standards.

The base stations 131-132 may be part of a WWAN that provides communication coverage for a large geographic area such as, for example, a city, a state, or an entire country. Each of the base stations 131-132 also may be referred to as a base transceiver station (BTS), a Node B, or an evolved Node B (eNB). Although only two base stations 131-132 are shown in FIG. 1 for simplicity, it is to be understood that the WWAN may be formed by any number of base stations. The WWAN may be a CDMA network, a TDMA network, an FDMA network, an Orthogonal Frequency Division Multiple Access (OFDMA) network, a Single-Carrier Frequency Division Multiple Access (SC-FDMA) network, an LTE network, a Time Division Synchronous Code Division Multiple Access (TD-SCDMA) network, or any other suitable cellular network. Thus, the WWAN may be a CDMA network, may be a UMTS network that implements Wideband-CDMA, may be a GSM network, or may be another suitable cellular network. In some aspects, the WWAN may operate according to the 3rd Generation Partnership Project 2 (3GPP2) specification.

The satellites 141-143 may be part of a satellite positioning system (SPS) such as, for example, the Global Positioning System (GPS), the Global Navigation Satellite System (GLONASS), Galileo, and any other global or regional satellite based positioning system. Each of the satellites 141-143 may broadcast satellite signals from which the wireless device 110 may determine its location on Earth (such as by using trilateration techniques on at least three received satellite signals).

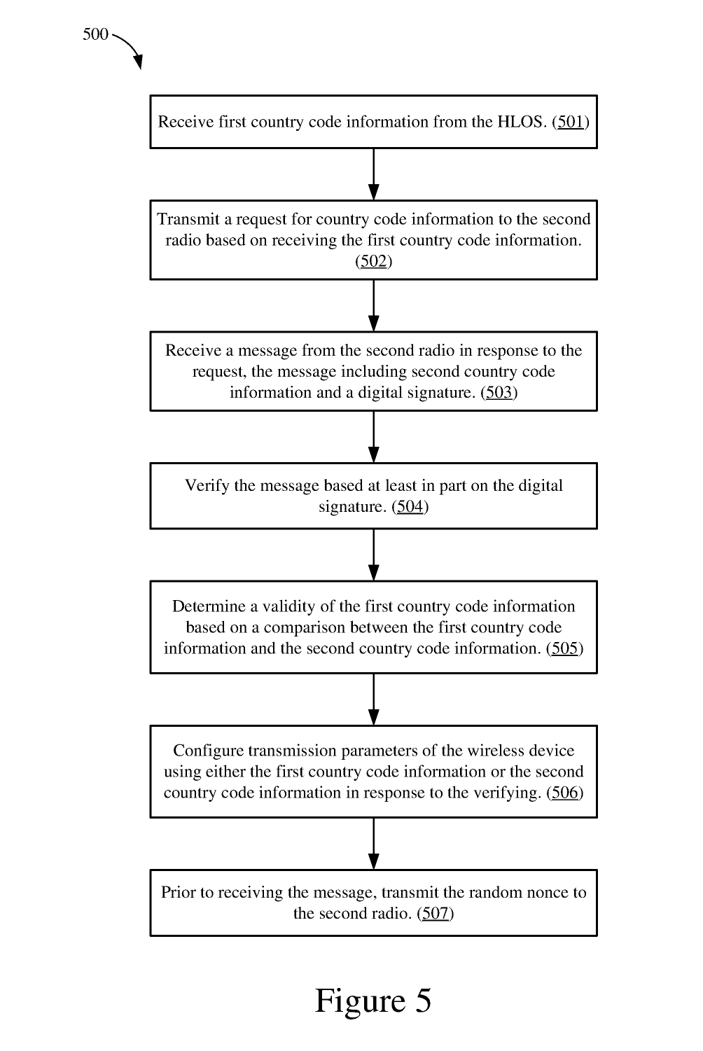

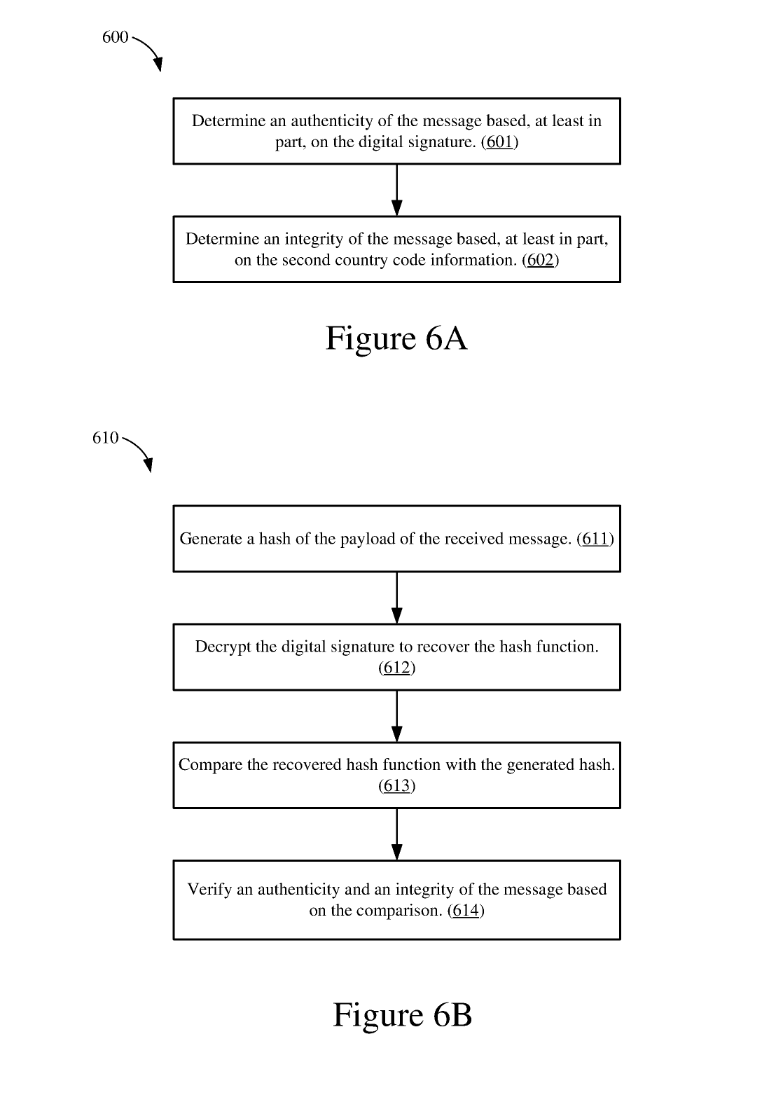

The wireless device 110 may communicate with other devices via the APs 121-122 (such as using Wi-Fi communications) and via the base stations 131-132 (such as using cellular communications). The wireless device 110 may be any suitable Wi-Fi and cellular enabled wireless device including, for example, a cell phone, personal digital assistant (PDA), tablet device, laptop computer, or the like. The wireless device may also be referred to as a user equipment (UE), a subscriber station, a mobile unit, a subscriber unit, a wireless unit, a remote unit, a mobile device, a wireless station (STA), a wireless communications device, a remote device, a mobile subscriber station, an access terminal, a mobile terminal, a wireless terminal, a remote terminal, a handset, a user agent, a mobile client, a client, or some other suitable terminology. For at least some implementations, the wireless device 110 may include one or more transceivers, one or more processing resources (e.g., processors and/or ASICs), one or more memory resources, and a power source (e.g., a battery). The memory resources may include a non-transitory computer-readable medium (e.g., one or more nonvolatile memory elements, such as EPROM, EEPROM, Flash memory, a hard drive, etc.) that stores instructions for performing operations described below with respect to FIGS. 5 and 6.

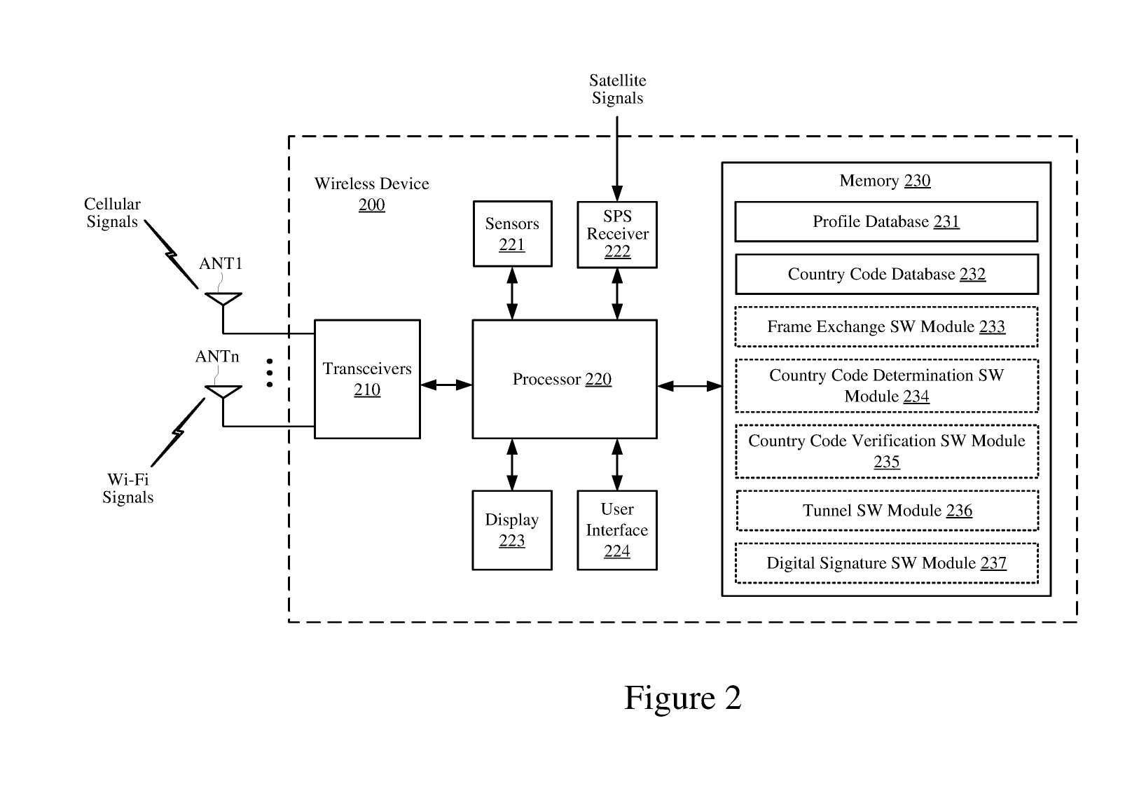

FIG. 2 shows an example wireless device 200. The wireless device 200 may be one implementation of the wireless device 110 of FIG. 1. The wireless device 200 includes one or more transceivers 210, a processor 220, a memory 230, and a number of antennas ANT1-ANTn. The transceivers 210 may be coupled to antennas ANT1-ANTn, either directly or through an antenna selection circuit (not shown for simplicity). The transceivers 210 may be used to transmit signals to and receive signals from APs, base stations, satellites, and any other suitable wireless device. In some implementations, the transceivers 210 may include a number of WLAN transceivers to transmit and receive Wi-Fi signals with other devices (such as according to the IEEE 802.11 standards), may include a number of cellular transceivers to transmit and receive cellular signals with other devices (such as according to the GSM, EDGE, LTE, and other applicable cellular protocols), and may include a number of Bluetooth transceivers to transmit and receive cellular signals with other devices (such as according to the Bluetooth specification). In some aspects, the transceivers 210 may be used to perform active and passive scanning operations to request or receive country code information from nearby APs.

Although not shown in FIG. 2 for simplicity, the transceivers 210 may include any number of transmit chains to process and transmit signals to other wireless devices via antennas ANT1-ANTn, and may include any number of receive chains to process signals received from antennas ANT1-ANTn. For purposes of discussion herein, processor 220 is shown as coupled between transceivers 210 and memory 230. For actual implementations, transceivers 210, processor 220, and memory 230 may be connected together using one or more buses (not shown for simplicity).

The wireless device 200 also may include one or more sensors 221, an SPS receiver 222, a display 223, a user interface 224, and other suitable components not shown for simplicity. The sensors 221 may be any suitable sensor including, for example, an accelerometer, a compass, and so on. The SPS receiver 222 may be compatible with the Global Positioning System (GPS), the Global Navigation Satellite System (GLONASS), and any other global or regional satellite based positioning system. For example, the SPS receiver 222 may use satellite signals received from the satellites 141-143 of FIG. 1 to determine the location of the wireless device 200 on Earth.

The display 223 may be any suitable display that allows content to be presented to a user of the wireless device 200. In some aspects, the display 223 may be a touch-sensitive display that allows the user to enter commands, instructions, and other input to the wireless device 200. The user interface 224 may be any suitable interface device or component that allows the user to provide input to the wireless device 200. In some aspects, the user interface 224 may include a keyboard (virtual or physical), a touch pad, and so on.

The memory 230 may include a database 231 that stores profile information for a plurality of wireless devices such as APs, base stations, wireless stations (STA), one or more satellites, and other wireless devices. The profile information for a particular AP may include, for example, the AP's service set ID (SSID), channel information, country code information, received signal strength indicator (RSSI) values, supported data rates, connection history with one or more APs, a trustworthiness value of the AP (such as indicating a level of confidence about the AP's location, broadcast country code information, and so on), and any other suitable information pertaining to or describing the operation of the AP. The profile information for a particular base station may include, for example, the base station's identifier, carrier and channel information, country code information, RSSI values, and any other suitable information pertaining to or describing the operation of the base station. The profile information for a particular STA may include information including, for example, STA's MAC address, supported data rates, and any other suitable information pertaining to or describing the operation of the STA. The profile information for a particular satellite may include, for example, channel information, PN codes, ephemeris data, and any other suitable information pertaining to or describing the operation of the satellite or an associated satellite system.

The memory 230 may also include a country code database 232. The country code database 232 may store country codes, authorized channel lists, maximum transmit power levels, and other suitable information pertaining to the regulatory constraints associated with a number of countries or regions. The IEEE 802.11 standards may operate in the 2.4 GHz frequency band and the 5 GHz frequency band. For one example, the 2.4 GHz frequency band, which occupies the frequency spectrum between 2400 and 2495 MHz, is divided into 14 staggered and overlapping frequency channels (denoted as channels 1 through 14). Different countries or regulatory domains may allow wireless devices to use different selections of 14 channels defined for the 2.4 GHz frequency spectrum (as well as for the 5 GHz frequency spectrum). Moreover, different countries or regulatory domains may impose different transmit power limits on wireless devices. Thus, to ensure compliance with applicable regulatory constraints, the wireless device 200 needs to know in which country or regulatory domain the wireless device 200 is operating, for example, so that its transceivers 210 can be configured to transmit wireless signals only on the authorized channels and with a transmit power settings that do not violate applicable transmit power limits.

The memory 230 also may include a non-transitory computer-readable storage medium (such as one or more nonvolatile memory elements, such as EPROM, EEPROM, Flash memory, a hard drive, and so on) that may store the following software (SW) modules:
a frame exchange software module 233 to create and exchange packets or frames with other wireless devices, for example, as described with respect to FIGS. 5 and 6A-6B;
a country code determination software module 234 to determine the country in which an AP or cellular base station is located based on one or more received country codes, for example, as described with respect to FIGS. 5 and 6A-6B;
a country code verification software module 235 to verify that the country code information currently stored in the country code database 232 is valid, for example, as described with respect to FIGS. 5 and 6A-6B;
a tunnel software module 236 to facilitate the secure exchange of country code information between various components of a radio subsystem of the wireless device 200, for example, as described with respect to FIGS. 5 and 6A-6B; and
a digital signature software module 237 to protect communications between the radio subsystem and an open source subsystem of the wireless device 200 with a digital signature, for example, as described with respect to FIGS. 5 and 6A-6B.
   Each software module includes instructions that, when executed by the processor 220, may cause the wireless device 200 to perform the corresponding functions. The non-transitory computer-readable medium of the memory 230 thus includes instructions for performing all or a portion of the operations described with respect to FIGS. 5 and 6A-6B.

The processor 220 may be any one or more suitable processors capable of executing scripts or instructions of one or more software programs stored in the wireless device 200 (such as within memory 230). For example, the processor 220 may execute the frame exchange software module 233 to create and exchange packets or frames with other wireless devices. The processor 220 may execute the country code determination software module 234 to determine the country in which an AP or a cellular base station is located based on one or more received country codes. The processor 220 may execute the country code verification software module 235 to verify that the country code information currently stored in the country code database 232 is valid. The processor 220 may execute the tunnel software module 236 to facilitate the secure exchange of country code information between various components of a radio subsystem of the wireless device 200. In some aspects, the secure tunnel may be a hardwired connection between the various radios that does not pass through the operating system. In other aspects, the secure tunnel may be a proprietary modem interface provided between the various radios. The processor 220 may execute the digital signature software module 237 to protect communications between the radio subsystem and an open source subsystem of the wireless device 200 with a digital signature.

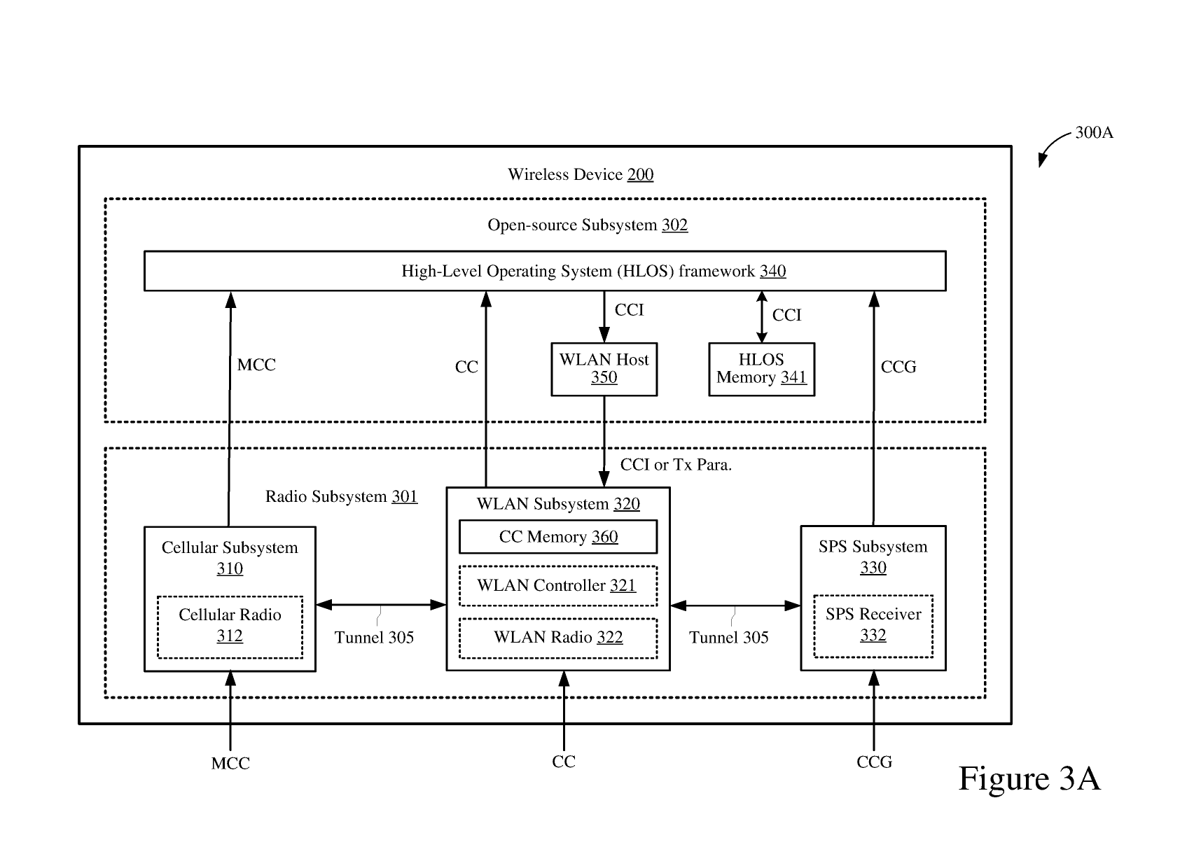

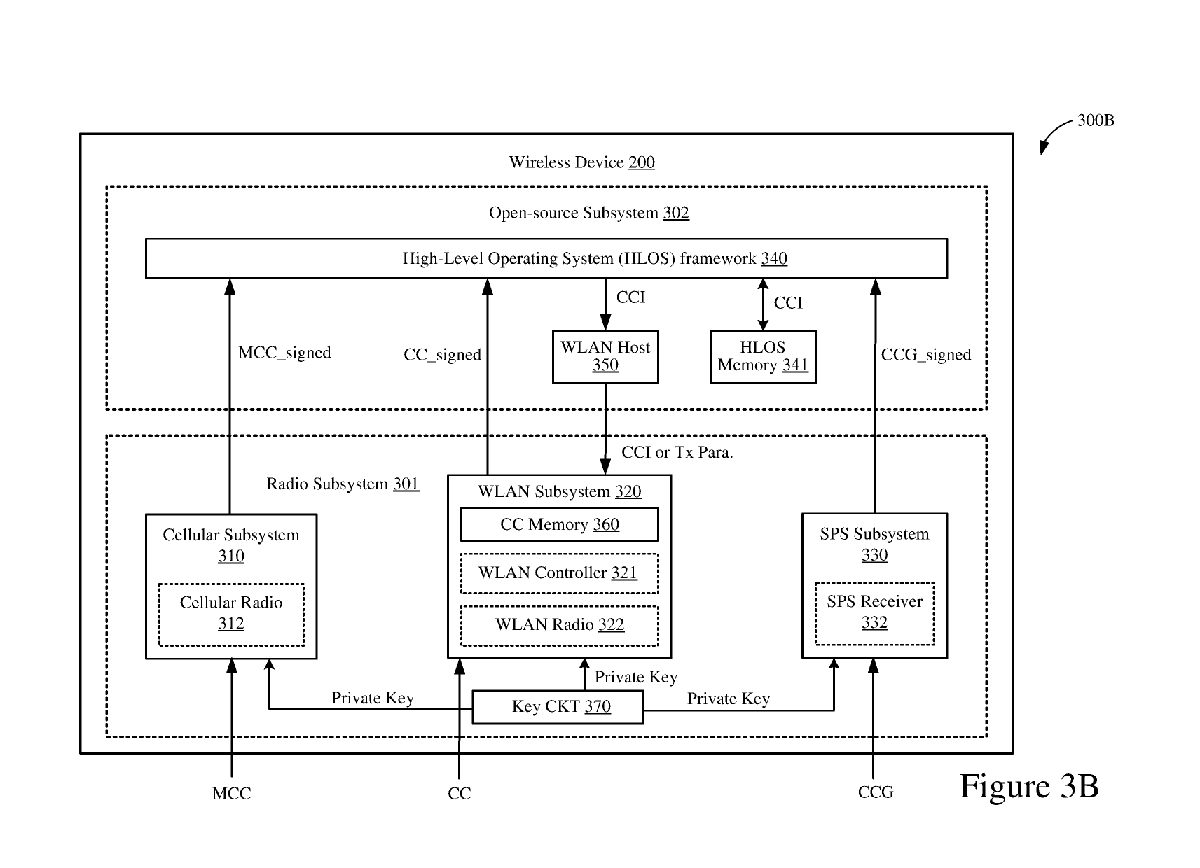

FIG. 3A is a functional illustration 300A of the wireless device 200 of FIG. 2. The functional illustration 300A depicts the wireless device 200 as including a radio subsystem 301 and an open-source subsystem 302. In some implementations, the radio subsystem 301 may represent or correspond to physical-layer components of the wireless device 200 (such as the transceivers 210 and the SPS receiver 222 of FIG. 2), and the open-source subsystem 302 may represent or correspond to high-layer functions of the wireless device (such as an application layer, an operating system, and a user interface) that may be implemented in least in part by the processor 220 and the memory 230 of FIG. 2).

The open-source subsystem 302 is shown to include a high-level operating system (HLOS) framework 340, a HLOS memory 341, and a WLAN host 350. The memory 341 may store a default country code that may be programmed therein, for example, by the manufacturer of the wireless device 200. In some implementations, the default country code may be stored in the memory 341 as a Board Data File (BDF). In some aspects, the HLOS framework 340 may possess a public key that allows the HLOS framework 340 to retrieve and access the default country code from the HLOS memory 341 (but prevents the HLOS framework 340 from modifying the default country code). In addition, or in the alternative, the HLOS framework 340 may obtain country code information as mobile country codes (MCC) from the cellular subsystem 310, may obtain country code information as country codes (CC) from the WLAN subsystem 320, and may obtain country code information as a country code group (CCG) from the SPS subsystem 330. In some aspects, the HLOS framework 340 may store country code information provided by the radio subsystem 301 in the HLOS memory 341.

The WLAN host 350 is coupled between the HLOS framework 340 and the WLAN subsystem 320, and may facilitate communications between the HLOS framework 340 and the WLAN subsystem 320. The WLAN host 350 also may be used to configure a number of operational parameters of the WLAN subsystem 320. In some implementations, the HLOS framework 340 may use the WLAN host 350 to provide country code information (such as the default country code stored in the HLOS memory 341) to the WLAN subsystem 320. In addition, or in the alternative, the HLOS framework 340 may use the WLAN host 350 to provide regulatory parameters (rather than the default country code) to the WLAN subsystem 320. The regulatory parameters may be used to set or configure transmission parameters (such as allowed channels, maximum transmit power levels, and so on) for the cellular radio 312 and the WLAN radio 322.

The radio subsystem 301 is shown to include a cellular subsystem 310, a WLAN subsystem 320, and an SPS subsystem 330. The cellular subsystem 310 includes at least a cellular radio 312 that can transmit and receive cellular signals (such as LTE signals). A cellular base station located in a country in which the wireless device 200 is operating may transmit MCC values to the wireless device 200 in a Sync Channel Message on a sync channel, in a System Parameters Message on a paging channel, or in an Extended System Parameters Message on the paging channel. The cellular radio 312 may provide the received MCC values to the HLOS framework 340.

The WLAN subsystem 320 includes at least a WLAN controller 321 and a WLAN radio 322. The WLAN radio 322 can transmit and receive WLAN signals (such as Wi-Fi signals) to and from other devices. An AP located in the country in which the wireless device 200 is operating may transmit country codes to the wireless device in beacon frames. In some aspects, the country codes may be contained in a Country Information Element (IE) included in the beacon frames. The WLAN radio 322 may provide the received country codes to the HLOS framework 340 via the WLAN controller 321. The WLAN controller 321 may be used to configure and control various operations of the WLAN radio 322. In some aspects, the WLAN controller 321 may execute firmware to dynamically adjust or re-configure various operating parameters of the WLAN radio 322, for example, based on the current country code stored in the wireless device 200.

The SPS subsystem 330 includes at least an SPS receiver 332 to receive satellite signals from a number of satellites. The SPS receiver 332 may provide the received satellite signals to the SPS subsystem 330, which may use the received satellite signals to determine the location of the wireless device 200 (and thus determine the country in which the wireless device 200 is located). In some aspects, the SPS subsystem 330 may indicate the determined country as CCG values to the HLOS framework 340.

The HLOS framework 340 may provide the country code information (such as MCC and CCG values) received from the radio subsystem 301 to the WLAN host 350, which in turn may provide the country code information to the WLAN subsystem 320.

In accordance with aspects of the present disclosure, the radio subsystem 301 may include a country code memory 360 that maintains the current country code for the wireless device 200. The country code memory 360 may be a non-volatile memory, and may be programmed with the default country code by the device manufacturer. In some aspects, the country code memory 360 may be shared by the cellular subsystem 310, the WLAN subsystem 320, and the SPS subsystem 330 using a shared memory interface (not shown for simplicity). In some implementations, the country code memory 360 may be provided within the WLAN subsystem 320, as depicted in the example of FIG. 3A. In other implementations, the country code memory 360 may be provided within an interface (not shown for simplicity) between the WLAN subsystem 320 and the WLAN host 350. In some other implementations, the country code memory 360 may be provided within another suitable portion of the radio subsystem 301.

The country code memory 360 residing in the radio subsystem 301 is not accessible by the HLOS framework 340, by the user interface, or by any other system components within the open-source subsystem 302. In this manner, a malicious user may not be able to gain access to and change the country code stored in the country code memory 360. In some aspects, the default country code stored in the country code memory 360 may be updated or overridden if the wireless device 200 receives a different country code from a trusted source such as, for example, the cellular radio 312, the WLAN radio 322, or the SPS receiver 332. In other aspects, the wireless device 200 may be programmed (by the manufacturer) as a single-country product, for example, by configuring the country code memory 360 to prevent any modification to the default country code stored therein.

The radio subsystem 301 also may include a secure data tunnel 305 coupled between the cellular subsystem 310, the WLAN subsystem 320, and the SPS subsystem 330. The data tunnel 305 may allow the cellular subsystem 310, the WLAN subsystem 320, and the SPS subsystem 330 to share received country code information with each other without tampering by the HLOS framework 340. In some aspects, the secure tunnel 305 may include a first hardwired connection between the cellular radio 312 and the WLAN radio 322, and may include a second hardwired connection between the WLAN radio 322 and the SPS receiver 332. In other aspects, the secure tunnel 305 may be a proprietary modem interface provided between the cellular radio 312 and the WLAN radio 322. Thus, although the cellular subsystem 310, the WLAN subsystem 320, and the SPS subsystem 330 may pass received country code information to the HLOS framework 340, the cellular subsystem 310, the WLAN subsystem 320, and the SPS subsystem 330 also may share the received country code information directly with each other via the secure data tunnel 305. In this manner, the cellular subsystem 310 and the WLAN subsystem 320 may independently verify the validity of country code information provided to the radio subsystem 301 by the HLOS framework 340.

For example, when the wireless device 200 is powered on, the HLOS framework 340 may retrieve the country code stored in the memory 341, and may pass the country code to the radio subsystem 301 via the WLAN host 350. The country code provided by the HLOS framework 340 may be used to configure the cellular radio 312 and the WLAN radio 322 to operate in a manner that is compliant with regulatory constraints imposed by the country or regulatory domain indicated by the country code. In other words, the cellular radio 312 and the WLAN radio 322 may be configured to transmit data using only the channels and power levels permitted by the country or regulatory domain indicated by the country code provided by the HLOS framework 340.

During operation of the wireless device 200, the cellular radio 312 may periodically receive valid MCC values transmitted from nearby base stations, and the WLAN radio 322 may periodically receive valid country codes transmitted from nearby APs. In some aspects, the HLOS framework 340 may receive a valid country code from the cellular subsystem 310, for example, based on MCC values received from a licensed WWAN network. The HLOS framework 340 also may receive a valid country code from the WLAN subsystem 320, for example, based on CC values received from a valid or trusted WLAN network. In addition, or in the alternative, the HLOS framework 340 may receive a valid country code from the SPS subsystem 330, for example, based on a position of the wireless device 200 determined using satellite signals received by the SPS receiver 332.

The HLOS framework 340 may compare the country code information received from the radio subsystem 301 with the current country code stored in the HLOS memory 341 of the wireless device 200 to determine if the wireless device 200 is operating in a new country or regulatory domain. If the country code information received from the radio subsystem 301 matches the country code stored in the HLOS memory 341, then the HLOS framework 340 may determine that the wireless device 200 is still operating in the same country (and therefore the current transmission parameters of the cellular radio 312 and the WLAN radio 322 are still valid).

Conversely, if the country code information received from the radio subsystem 301 does not match the current country code stored in the HLOS memory 341, then the HLOS framework 340 may determine that the wireless device 200 is operating is a new country. In response thereto, the HLOS framework 340 may update the current country code with the country code information received from the radio subsystem 301, for example, by storing the received country code as the current country code in the HLOS memory 341. In some implementations, the HLOS framework 340 may provide the updated country code as new MCC and CCG values to the radio subsystem 301, which in turn may re-configure the transmission parameters of the cellular radio 312 and the WLAN radio 322 to be compliant with the regulatory constraints associated with the new country. It is noted that although the HLOS framework 340 may be vulnerable to malicious users, the HLOS framework 340 and other system components need to know the current country code.

To prevent a malicious user from accessing the HLOS framework 340 and improperly modifying the current country code (such as to allow the wireless device 200 to transmit data on forbidden wireless channels and to transmit data at power levels in excess of applicable regulatory transmit power limits), the WLAN controller 321 may verify that a country code provided by the HLOS framework 340 is valid prior to modifying the country-specific transmission parameters of the radio subsystem 301. In some implementations, the WLAN controller 321 may verify the validity of the country code provided by the HLOS framework 340 by comparing the country code provided by the HLOS framework 340 with the country code currently stored in the country code memory 360. In some aspects, the WLAN controller 321 may retrieve the current country code from the country code memory 360 during boot-up of the wireless device 200. If the country code provided by the HLOS framework 340 matches the current country code retrieved from the country code memory 360, the WLAN controller 321 may verify the validity of the provided country code and allow modification of the transmission parameters of the cellular radio 312 and the WLAN radio 322 in accordance with the country code provided by the HLOS framework 340. Conversely, if the country code provided by the HLOS framework 340 does not match the current country code retrieved from the country code memory 360, the WLAN controller 321 may not verify the provided country code and may not modify the transmission parameters of the cellular radio 312 and the WLAN radio 322 based on country code information provided by the HLOS framework 340.

In some implementations, when new country code information (such as a new MCC value) is received by the cellular radio 312, the cellular subsystem 310 may forward the new country code information to the WLAN controller 321 via the secure tunnel 305. Similarly, when new country code information (such as a new CCG value) is determined by the SPS subsystem 330, the SPS subsystem 330 may forward the new country code information to the WLAN controller 321 via the secure tunnel 305. In some aspects, the WLAN radio 322 may forward country codes received in beacon frames to the WLAN controller 321.

The WLAN controller 321 may compare new country code information received from the cellular radio 312, the WLAN radio 322, the SPS receiver 332, or any combination thereof with the current country code stored in the country code memory 360. In some implementations, the WLAN controller 321 may assign different weights to country code information provided by the cellular radio 312, the WLAN radio 322, and the SPS subsystem 330. In some implementations, the WLAN controller 321 may use the results of the comparison to confirm the validity of any new country code information provided by the HLOS framework 340. One example operation for verifying the validity of updated country code information provided by the HLOS framework 340 is as follows:
if a new country code provided by the HLOS framework 340 does not match the current country code stored in the country code memory 360, then the WLAN controller 321 ignores the request by the HLOS framework 340, does not update or change the country code stored in the country code memory 360, and forwards the current country code stored in the country code memory 360 to the HLOS framework 340;
if a new country code provided by the HLOS framework 340 conflicts with new country code information provided by the WLAN radio 322 (such as a valid country code received in a valid Country IE), the WLAN controller 321 ignores the request by the HLOS framework 340, may update the country code stored in the country code memory 360 with the new country code received by the WLAN radio 322, and may pass the new country code received by the WLAN radio 322 to the HLOS framework 340;
if a new country code is provided by the HLOS framework 340 and neither the cellular radio 312, the WLAN radio 322, nor the SPS subsystem 330 provides country code information, then the WLAN controller 321 may update the country code stored in the country code memory 360 with the new country code provided by the HLOS framework 340; and
if a new country code received by the cellular radio 312 conflicts with country code group information provided by the SPS receiver 332, the WLAN controller 321 may disable the WLAN radio 322 and send an error code to the HLOS framework 340.

The above operation may be repeated each time either the cellular radio 312, the WLAN radio 322, or the SPS receiver 332 detects a change in country code information. In this manner, the WLAN controller 321 may allow country code information provided by the cellular radio 312 and the SPS subsystem 330 to override any country code updates requested by the HLOS framework 340.

In other implementations, when the HLOS framework 340 provides new country code information to the radio subsystem 301, the WLAN controller 321 may transmit a request for country code information to the cellular radio 312. In response thereto, the cellular radio 312 may transmit a message to the WLAN controller 321 that contains country code information received from a cellular network. The WLAN controller 321 may verify the validity of the country code information provided by the HLOS framework 340 based on a comparison with the country code information provided by the cellular radio 312.

FIG. 3B is another functional illustration 300B of the wireless device 200 of FIG. 2. The functional illustration 300B is similar to the functional illustration 300A described with respect to FIG. 3A, except that the functional illustration 300B depicted in FIG. 3B uses digital signatures (or a suitable encryption technique) to prevent unauthorized tampering of country code information stored in the wireless device 200. For the example implementation depicted in FIG. 3B, country code information received or determined by the radio subsystem 301 may be protected with a digital signature and then passed to the HLOS framework 340. In some implementations, the radio subsystem 301 may include a key circuit 370 that implements a public key-private key system to protect country code information provided from the radio subsystem 301 to the HLOS framework 340, and to protect country code information provided by the HLOS framework 340 to the radio subsystem 301.

In some implementations, the key circuit 370 may provide a private key to cellular subsystem 310, the WLAN subsystem 320, and the SPS subsystem 330. The cellular subsystem 310 may use the private key to protect MCC values received from a cellular network with a digital signature, and may provide a signed MCC value (MCC_signed) to the HLOS framework 340. The SPS subsystem 330 may use the private key to protect CCG values determined from received satellite signals with a digital signature, and may provide a signed CCG value (CCG_signed) to the HLOS framework 340. In some aspects, the WLAN subsystem 320 also may use the private key to protect country codes received from a WLAN network with a digital signature, and provide a signed country code to the HLOS framework 340.

The HLOS framework 340 may pass the signed country code information to the radio subsystem 301 via the WLAN host 350. The WLAN controller 321 may use a public key to verify the country code information received from the HLOS framework 340, and thereafter confirm the validity of any country code changes requested by the HLOS framework HLOS framework 340, for example, in a manner similar to that described with respect to FIG. 3A.

By passing signed country code information between the radio subsystem 301 and the HLOS framework 340, malicious users may not be able to determine or change country codes shared between the cellular radio 312, the WLAN radio 322, and the SPS receiver 332 (unless they obtain a valid public key from the device manufacturer). In some aspects, the private key may be available to authorized developers, for example, so that the authorized developers can modify the country code or other WLAN transmission parameters.

In other implementations, when the HLOS framework 340 provides new country code information to the radio subsystem 301, the WLAN controller 321 may transmit a request for country code information to the cellular radio 312. In response thereto, the cellular radio 312 may generate a message containing country code information received from a cellular network and a digital signature. In some aspects, the cellular radio 312 may generate a fixed-length cryptographic hash of the message's payload (which includes the country code information), and may sign the hash using a private key to generate a digital signature. The cellular radio 312 may transmit the digital signature and the message to the WLAN controller 321. The message may be any suitable message, frame, or signal that can transmit the digital signature and the country code information from the cellular radio 312 to the WLAN controller 321. The message, once protected against tampering by the digital signature, may be passed through the HLOS framework 340.

Upon reception of the message, the WLAN controller 321 may locally regenerate a hash of the message's payload, and may use a public key to verify the digital signature and to recover the hash generated by the cellular radio 312. In some aspects, the WLAN controller 321 may compare the locally regenerated hash with the recovered hash to verify the integrity of the payload (such as the country code information provided by the cellular radio 312), and may use the decrypted digital signature to verify the authenticity of the message.

Aspects of the present disclosure also may be used to protect regulatory domain data. For example, the cellular subsystem 310 and the WLAN subsystem 320 may include look-up tables (or other suitable memory devices) that store authorized channels and transmit power limits for a number of different countries or regulatory domains. When the wireless device 200 begins operating in a new country, the WLAN subsystem 320 may access the look-up tables to determine the authorized channels and transmit power limits applicable to the new country, and thereafter verify the validity of country code changes requested by the HLOS framework 340.

In some implementations, regulatory domain data may be verified by the technology provider, the original equipment manufacturer, or both prior to storage in the look-up tables. However, some wireless devices may be configured to also store the regulatory domain data in memory residing in the HLOS framework 340 or the WLAN host 350, which as discussed above is susceptible to tampering by malicious users. Although it may be possible to encrypt the regulatory domain data, encrypting the regulatory domain data may not be practical due to complexities of the WLAN system design and current HLOS requirements.

Accordingly, aspects of the present disclosure also may be used to prevent the improper tampering of country code information even when the regulatory domain data is stored in the HLOS framework 340 or the WLAN host 350. In some implementations, a fail-safe regulatory domain protection scheme may include two components: storing fail-safe regulatory domain data in the radio subsystem 301, and utilizing a validation technique to ensure the integrity of the regulatory domain data maintained in the HLOS framework 340 or the WLAN host 350. As described below, aspects of the present disclosure may prevent the unauthorized tampering of country code information in wireless devices using minimal resources while allowing the end user to modify the regulatory domain data when necessary.

### Fail-Safe Regulatory Domain Data

For the fail-safe regulatory domain data, a compact “fail-safe” version of the regulatory domain data may be created by the device manufacturer. In some aspects, the device manufacturer may select a desired fail-safe data (such as based on a desired level of protection) and store the fail-safe data in the radio subsystem 301 at the time of manufacture. In some aspects, the fail-safe data may be stored in the country code memory 360 or other suitable memory that is not accessible by the HLOS framework 340. The fail-safe data may be accessed by the WLAN controller 321 and then compared with the operating frequency and transmit power requested by the HLOS framework 340. The WLAN controller 321 may limit operation of the WLAN radio 322 to the values specified by the fail-safe data, for example, based on the current country codes stored in the country code memory 360.

The fail-safe data may include a data set for each of 3 regions: the United States (where the FCC is the regulatory agency), Europe (where the ETSI is the regulatory agency), and the Rest of World (ROW). Each data set contains the list of allowed 2.4 GHz, 5 GHz, and 60 GHz channels of operation and the transmit power limits for each region.

In some implementations, the wireless device 200 may maintain a “strict” fail-safe data set and a “moderate” fail-safe data set. The strict fail-safe data set may specify channel frequencies and transmit power levels that are in strict compliance with applicable regulatory constraints. The moderate fail-safe data set may specify less strict channel frequencies and transmit power levels, for example, to minimize unnecessarily restricting operation of the wireless device 200. For one example, the device manufacturer may configure the wireless device 200 for sale in the U.S. using the strict fail-safe data set to ensure a high level of compliance with FCC regulations. For another example, the device manufacturer may configure the wireless device 200 for sale in another region using the moderate fail-safe data set, for example, to maximize performance.

The fail-safe data sets may be stored in the radio subsystem 301, for example, to prevent access by the HLOS framework 340. In some implementations, the fail-safe data sets may be used to override all requests from the HLOS framework 340 or the WLAN host 350 to operate on wireless channels or at power levels likely to be illegal based on the current country code stored in the country code memory 360. In some aspects, the regulatory domain data may not be modified and replaced by the HLOS framework 340, and the fail-safe data sets may not be modified by any third party.

An example operation for implementing the fail-safe technique in the U.S. is as follows:
If the country code=USA, then enforce the fail-safe limits and end the operation;
If the number of Tx chains >=4, then enforce then fail-safe limits and end the operation;
If the Outdoor Flag in the Board Data File=Yes, then enforce the fail-safe Limits and end the operation;
Bypass fail-safe Limits if none of above apply.

More than one technique may be developed and implemented by the device manufacturer based on the particular country or regulatory domain in which the wireless device 200 is to be sold. For example, one example technique for wireless devices 200 intended to be sold in the U.S. may utilize the “strict” fail-safe data set, for example, to ensure compliance with FCC regulations.

In other implementations, the fail-safe data set may allow the HLOS framework 340 (or the end user) to restrict operation of the wireless device 200 to less than all of the authorized channels and to maintain transmit power levels of the wireless device 200 at levels lower than the fail-safe transmit power limits.

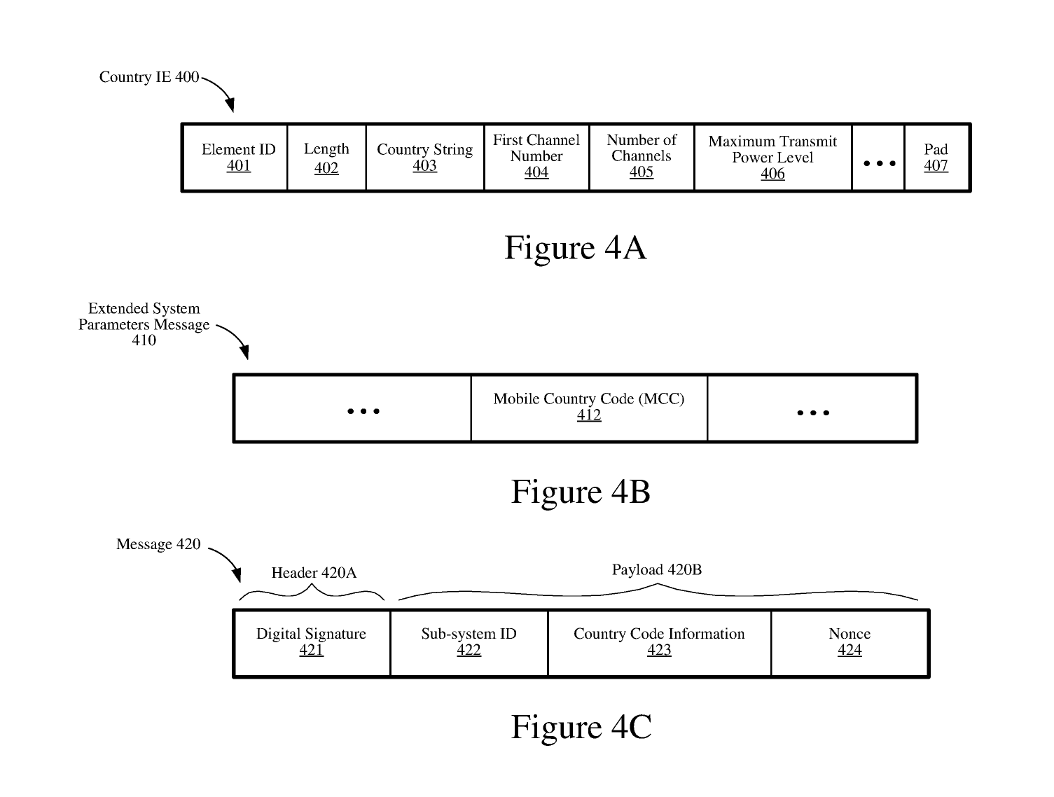

FIG. 4A depicts a Country Information Element (IE) 400 that may be included in a beacon frame transmitted in a wireless local area network (WLAN). The Country IE 400 may include an Element ID field 401, a Length field 402, a Country String field 403, a First Channel field 404, a Number of Channels field 405, a Maximum Transmit Power Level field 406, and an optional Pad field 407. The Element ID field 401 may store an element ID value indicating that the country IE 400 contains country code information transmitted from a nearby AP. The Length field 402 may store a value indicating a length (in bytes) of the country IE 400. The Country String field 403 may store a country code that indicates the country in which the transmitting AP resides. The First Channel field 404 may indicate the lowest channel number in a subband described in the Country IE 400. The Number of Channels field 405 indicates the number of frequency channels in the subband. The Maximum Transmit Power Level field 406 indicates transmit power limits for each subband in the channel associated with the transmitting AP. The optional Pad field 407 may include padding bits so that the Country IE 400 has a certain length.

FIG. 4B depicts an Extended System Parameters Message 410. The Extended System Parameters Message 410 may be transmitted in a WWAN such as a cellular network. For example, a base station in a CDMA cellular network may transmit the Extended System Parameters Message 410 to advertise a number of parameters and operational constraints to nearby wireless devices. The Extended System Parameters Message 410 includes a Mobile Country Code (MCC) field 412 and a number of other fields (not shown for simplicity). The MCC field 412 stores a 3-digit MCC value that indicates the country in which the transmitting base station is located. The encoding of the 3-digit MCC value into a 10-bit binary value for the MCC field is described, for example, in the 3GPP2 specification.

For a GSM network, each base station regularly broadcasts a System Information Type 3 message on a broadcast control channel (BCCH). This message contains a Location Area Identification information element that carries a 3-digit MCC value and a 3-digit MNC value for the GSM network. For a UMTS network, each base station regularly broadcasts a System Information message on a BCCH. This message contains a Master Information block that carries a PLMN Identity for a Public Land Mobile Network (PLMN) in which the UMTS network belongs. The PLMN Identity is composed of a 3-digit MCC value and a 2 or 3-digit MNC value for the PLMN.

FIG. 4C depicts an example message 420 that may be transmitted from a second radio to a first radio in a wireless device. In some implementations, the message 420 may be used to exchange country code information between different radios of the radio subsystem 301 of the wireless device 200. The message 420 may include a header 420A containing a digital signature 421, and may include a payload 420B containing a sub-system ID 422, country code information 423, and a nonce 424. The digital signature 421 may be created by a sender of the message 420, for example, by hashing contents of the payload 420B and then digitally signing (or otherwise encrypting) the hash. The sub-system ID 422 may indicate one of the radio subsystems of the wireless device 200. The country code information 423 may be any suitable country code information received from a trusted source such as, for example, the cellular radio 312, the WLAN radio 322, or the SPS receiver 332. The nonce 424 may be a random number that can be used to prevent replay attacks. In some aspects, a recipient of the message 420 may periodically generate the nonce 424 and transmit the generated nonce 424 to the sender of the message 420. The sender may use the nonce 424 when generating a hash of the message payload 420B, and may thereafter insert the resulting digital signature and the nonce into the message 420. In some implementations, the received nonce may be compared with the transmitted nonce. If there is not a match, then a replay attack may be indicated.

FIG. 5 is an illustrative flow chart depicting an example operation 500 for protecting the country code stored in a wireless device. Although described below with respect to the wireless device 200 of FIGS. 2 and 3A-3B, the example operation 500 may be performed by any suitable wireless device. For purposes of discussion herein, a default country code may be stored in the HLOS memory 341 (such as by a manufacturer of the wireless device 200), and country code information received from one or more wireless networks (such a cellular network or a Wi-Fi network) may be stored in the country code memory 360 residing in the radio subsystem 301 of the wireless device 200.

A first radio of the wireless device 200 may receive first country code information from the HLOS (501). In some implementations, the first country code information received from the HLOS may be the default country code information stored in the HLOS memory 341. In other implementations, the first country code information received from the HLOS may be country code information received from a wireless network and provided to the HLOS by the radio subsystem 301.

The first radio may transmit a request for country code information to the second radio based on receiving the first country code information (502). In some aspects, the first radio may be the WLAN radio 322, the second radio may be the cellular radio 312, the first country code information may be a Board Data File (BDF) stored in the HLOS, and the second country code information may be a mobile country code (MCC) received from a cellular network. In other aspects, the first radio may be the cellular radio 312, the second radio may be the WLAN radio 322, the first country code information may be a BDF stored in the HLOS, and the second country code information may be a country code received from a Wi-Fi network. In other aspects, the first radio may be the WLAN radio 322, the second radio may be the SPS receiver 332, the first country code information may be a BDF stored in the HLOS, and the second country code information be a country code received from the SPS receiver 332.

In response to the request, the second radio may generate a message and transmit the message to the first radio. In some implementations, the message may include second country code information and a digital signature. The second country code information may be received from a wireless network associated with the first radio. The message may be any suitable message, frame, or signal that can transmit the second country code information and the digital signature to the first radio. In some aspects, the second country code information may be received from a cellular network. In other aspects, the second country code information may be received from a Wi-Fi network. In some other aspects, the second country code information may be received from the SPS receiver 332.

The first radio may receive the message from the second radio (503). In some implementations, the message may be sent from the second radio to the first radio via the HLOS using a secure tunnel. In addition, or in the alternative, the message may include a header including the digital signature, and may include a payload including the second country code information, a subsystem identification (ID), and a random nonce (such as shown in FIG. 4C).

The first radio may verify the message based at least in part on the digital signature (504), and may determine a validity of the first country code information based on a comparison between the first country code information and the second country code information (505). In some implementations, the message may be verified by determining an authenticity of the message based at least in part on the digital signature, and by determining an integrity of the message based at least in part on the second country code information. In other implementations, the digital signature may be based on a hash function of the payload, and the message may be verified using a public key, for example, as described with respect to FIG. 6A.

The first radio may configure transmission parameters of the wireless device using either the first country code information or the second country code information in response to the verifying (506). In addition, or in the alternative, the first radio may, prior to receiving the message, transmit the random nonce to the second radio (507). In some implementations, the first radio may transmit the random nonce to the second device to prevent replay attacks.

FIG. 6A is an illustrative flow chart depicting an example operation 600 for verifying the message. The example operation 600 may correspond to the step or operation 504 of FIG. 5. In some implementations, the first radio may determine an authenticity of the message based, at least in part, on the digital signature (601), and may determine an integrity of the message based, at least in part, on the second country code information (602).

FIG. 6B is an illustrative flow chart depicting another example operation 610 for verifying the message. The example operation 610 may correspond to the step or operation 504 of FIG. 5 in implementations for which the digital signature is based on a hash function of the payload of the message. In some implementations, the second radio may create a fixed-length cryptographic hash of the message payload (which may include the second country code information, the subsystem ID, and the random nonce). The second radio may use a private key to sign the hash. The signed hash is the digital signature that accompanies the payload in the message. The signing operation, which may use any suitable digital signature algorithm (such as RSA or ECDSA), protects the payload from tampering.

Upon receiving the message payload and the digital signature, the first radio may generate a hash locally over the message payload (611). The first radio may use a public key to verify the digital signature (612). The first radio may compare the regenerated local hash with the hash function generated by the second radio (613). In some implementations, the first radio may decrypt the digital signature using the public key to recover the hash function generated by the second radio. Thereafter, the first radio may verify the message based on the comparison (614).

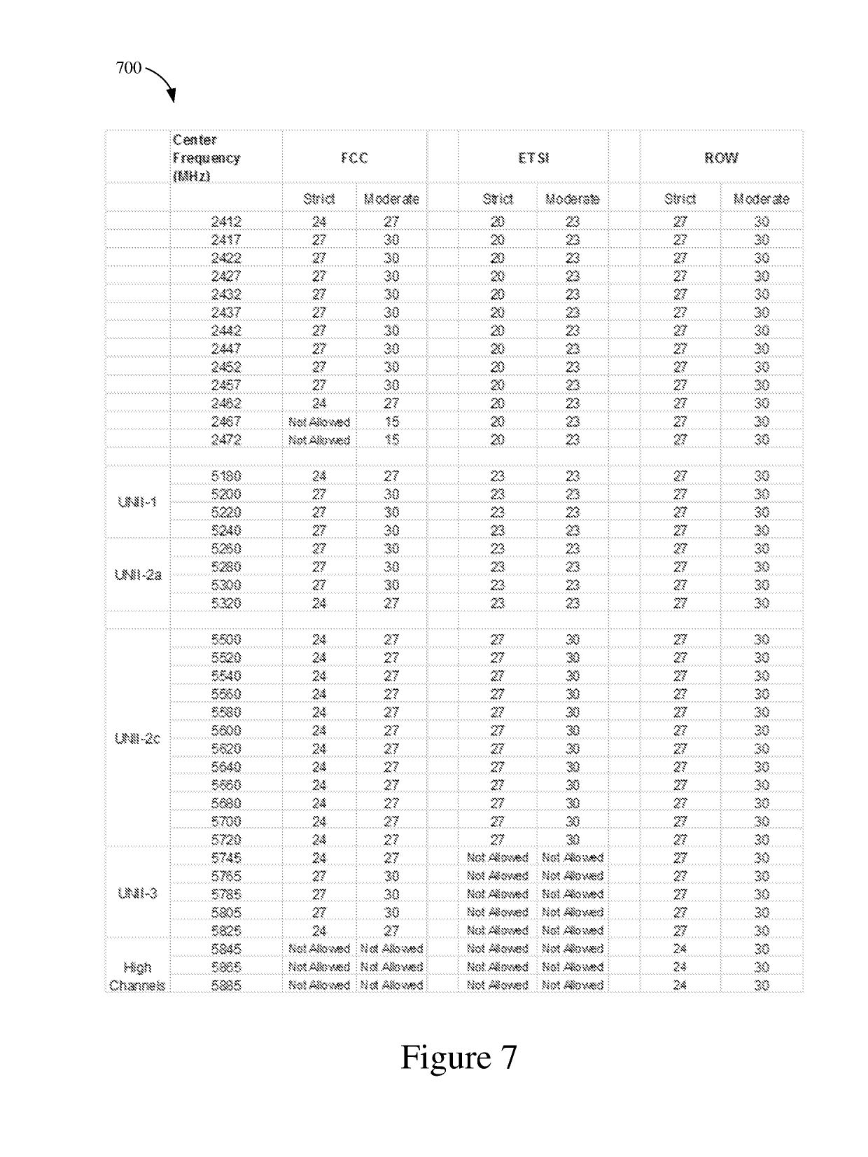

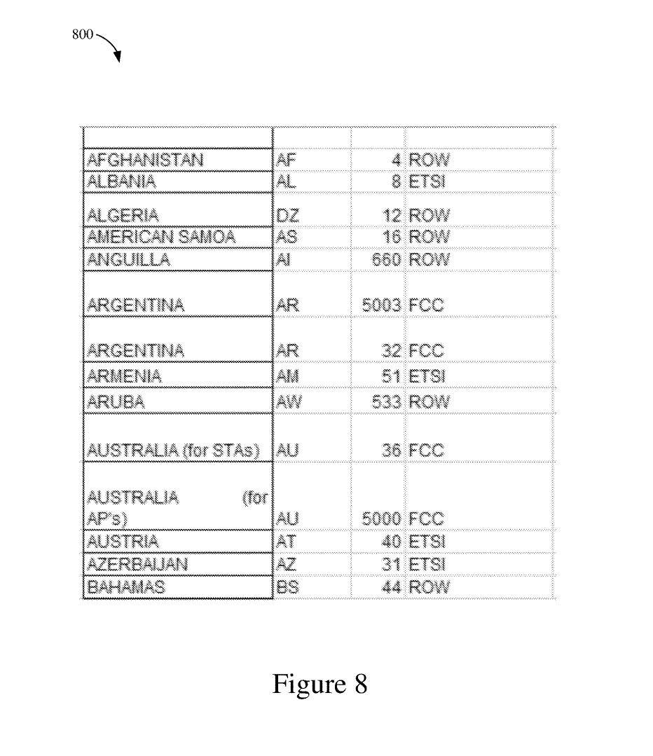

FIG. 7 is a table 700 depicting example transmit power levels for a number of regulatory domains, and FIG. 8 is a table 800 depicting example transmit power levels for a number of other regulatory domains.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, e.g., a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

What is claimed is:

1. A method of preventing unauthorized modification of country code information stored in a wireless device comprising a high-level operating system (HLOS) and a radio subsystem including at least a first radio and a second radio, the method performed by the first radio and comprising:
receiving first country code information from the HLOS;
transmitting a request for country code information to the second radio based on receiving the first country code information;
receiving a message from the second radio in response to the request, the message including second country code information and a digital signature;
verifying the message based at least in part on the digital signature;
determining a validity of the first country code information based on a comparison between the first country code information and the second country code information; and
configuring transmission parameters of the wireless device using either the first country code information or the second country code information in response to the verifying.

2. The method of claim 1, wherein the first radio comprises a WLAN transceiver, the second radio comprises a cellular transceiver, the first country code information comprises a Board Data File (BDF) stored in the HLOS, and the second country code information comprises a mobile country code (MCC) received from a cellular network.

3. The method of claim 1, wherein the first radio comprises a cellular transceiver, the second radio comprises a WLAN transceiver, the first country code information comprises a Board Data File (BDF) stored in the HLOS, and the second country code information comprises a country code received from a Wi-Fi network.

4. The method of claim 1, wherein the first radio comprises a WLAN transceiver, the second radio comprises a satellite positioning system (SPS) receiver, the first country code information comprises a Board Data File (BDF) stored in the HLOS, and the second country code information comprises a country code received from the SPS.

5. The method of claim 1, wherein the message is sent from the second radio to the first radio via the HLOS using a secure tunnel.

6. The method of claim 1, wherein verifying the message comprises:
determining an authenticity of the message based at least in part on the digital signature; and
determining an integrity of the message based at least in part on the second country code information.

7. The method of claim 1, wherein the message comprises:
a header including the digital signature; and
a payload including the second country code information, a subsystem identification (ID), and a random nonce.

8. The method of claim 7, wherein the digital signature is based on a hash function of the payload, and verifying the message comprises:
generating a hash of the payload of the received message;
decrypting the digital signature to recover the hash function;
comparing the recovered hash function with the generated hash; and
verifying an authenticity and an integrity of the message based on the comparison.

9. The method of claim 8, wherein the second radio uses a private key to generate the digital signature from the hash function of the payload, and the first radio uses a public key to decrypt the digital signature.

10. The method of claim 7, further comprising:
prior to receiving the message, transmitting the random nonce to the second radio.

11. An apparatus, comprising:
a high-level operating system (HLOS);
a radio subsystem including at least a first radio and a second radio;
one or more processors; and
a memory comprising instructions that, when executed by the one or more processors, cause the first radio to:
receive first country code information from the HLOS;
transmit a request for country code information to the second radio based on receiving the first country code information;
receive a message from the second radio in response to the request, the message including second country code information and a digital signature;
verify the message based at least in part on the digital signature;
determine a validity of the first country code information based on a comparison between the first country code information and the second country code information; and
configure transmission parameters of the apparatus using either the first country code information or the second country code information in response to the verifying.

12. The apparatus of claim 11, wherein the first radio comprises a WLAN transceiver, the second radio comprises a cellular transceiver, the first country code information comprises a Board Data File (BDF) stored in the HLOS, and the second country code information comprises a mobile country code (MCC) received from a cellular network.

13. The apparatus of claim 11, wherein the first radio comprises a cellular transceiver, the second radio comprises a WLAN transceiver, the first country code information comprises a Board Data File (BDF) stored in the HLOS, and the second country code information comprises a country code received from a Wi-Fi network.

14. The apparatus of claim 11, wherein the first radio comprises a WLAN transceiver, the second radio comprises a satellite positioning system (SPS) receiver, the first country code information comprises a Board Data File (BDF) stored in the HLOS, and the second country code information comprises a country code received from the SPS.

15. The apparatus of claim 11, wherein the message is sent from the second radio to the first radio via the HLOS using a secure tunnel.

16. The apparatus of claim 11, wherein execution of the instructions to verify the message further causes the first radio to:
determine an authenticity of the message based at least in part on the digital signature; and
determine an integrity of the message based at least in part on the second country code information.

17. The apparatus of claim 11, wherein the message comprises:
a header including the digital signature; and
a payload including the second country code information, a subsystem identification (ID), and a random nonce.

18. The apparatus of claim 17, wherein the digital signature is based on a hash function of the payload, and wherein execution of the instructions to verify the message further causes the first radio to:
generate a hash of the payload of the received message;
decrypt the digital signature to recover the hash function;
compare the recovered hash function with the generated hash; and
verify an authenticity and an integrity of the message based on the comparison.

19. The apparatus of claim 18, wherein the second radio uses a private key to generate the digital signature from the hash function of the payload, and the first radio uses a public key to decrypt the digital signature.

20. The apparatus of claim 17, wherein execution of the instructions to further causes the first radio to:
prior to receiving the message, transmit the random nonce to the second radio.

21. A non-transitory computer-readable medium storing instructions that, when executed by one or more processors of a wireless device comprising a high-level operating system (HLOS) and a radio subsystem including at least a first radio and a second radio, cause the first radio to perform operations comprising:
receiving first country code information from the HLOS;
transmitting a request for country code information to the second radio based on receiving the first country code information;
receiving a message from the second radio in response to the request, the message including second country code information and a digital signature;
verifying the message based at least in part on the digital signature;
determining a validity of the first country code information based on a comparison between the first country code information and the second country code information; and
configuring transmission parameters of the wireless device using either the first country code information or the second country code information in response to the verifying.

22. The non-transitory computer-readable medium of claim 21, wherein the first radio comprises a WLAN transceiver, the second radio comprises a cellular transceiver, the first country code information comprises a Board Data File (BDF) stored in the HLOS, and the second country code information comprises a mobile country code (MCC) received from a cellular network.

23. The non-transitory computer-readable medium of claim 21, wherein the first radio comprises a cellular transceiver, the second radio comprises a WLAN transceiver, the first country code information comprises a Board Data File (BDF) stored in the HLOS, and the second country code information comprises a country code received from a Wi-Fi network.

24. The non-transitory computer-readable medium of claim 21, wherein the first radio comprises a WLAN transceiver, the second radio comprises a satellite positioning system (SPS) receiver, the first country code information comprises a Board Data File (BDF) stored in the HLOS, and the second country code information comprises a country code received from the SPS.

25. The non-transitory computer-readable medium of claim 21, wherein the message is sent from the second radio to the first radio via the HLOS using a secure tunnel.

26. The non-transitory computer-readable medium of claim 21, wherein verifying the message comprises:
determining an authenticity of the message based at least in part on the digital signature; and
determining an integrity of the message based at least in part on the second country code information.

27. The non-transitory computer-readable medium of claim 21, wherein the message comprises:
a header including the digital signature; and
a payload including the second country code information, a subsystem identification (ID), and a random nonce.

28. The non-transitory computer-readable medium of claim 27, wherein the digital signature is based on a hash function of the payload, and wherein execution of the instructions for verifying the message causes the first radio to perform operations further comprising:
generating a hash of the payload of the received message;
decrypting the digital signature to recover the hash function;
comparing the recovered hash function with the generated hash; and
verifying an authenticity and an integrity of the message based on the comparison.

29. The non-transitory computer-readable medium of claim 28, wherein the second radio uses a private key to generate the digital signature from the hash function of the payload, and the first radio uses a public key to decrypt the digital signature.

30. A wireless device comprising a high-level operating system (HLOS) and a radio subsystem including at least a first radio and a second radio, the wireless device comprising:
means for receiving first country code information from the HLOS;
means for transmitting a request for country code information to the second radio based on receiving the first country code information;
means for receiving a message from the second radio in response to the request, the message including second country code information and a digital signature;
means for verifying the message based, at least in part, on the digital signature;
means for determining a validity of the first country code information based on a comparison between the first country code information and the second country code information; and
means for configuring transmission parameters of the wireless device using either the first country code information or the second country code information in response to the verifying.
